(19) United States
(12) Patent Application Publication
(10) Pub. No.: US 2025/0378779 A1
(43) Pub. Date: Dec. 11, 2025

(54) PIXEL, DISPLAY DEVICE INCLUDING THE PIXEL, AND ELECTRONIC APPARATUS INCLUDING THE DISPLAY DEVICE

(71) Applicant: Samsung Display Co., LTD., Yongin-si (KR)

(72) Inventor: KYUNGHOON CHUNG, Yongin-si (KR)

(21) Appl. No.: 19/075,359

(22) Filed: Mar. 10, 2025

(30) Foreign Application Priority Data
Jun. 5, 2024 (KR) 10-2024-0073409

(51) Int. Cl. G09G 3/32; G09G 3/3233

(52) U.S. Cl. CPC G09G 3/32; G09G 3/3233; G09G 2300/0814; G09G 2300/0857; G09G 2310/0289; G09G 2310/08; G09G 2320/064; G09G 2330/021

(57) ABSTRACT

A pixel includes a light-emitting element through which driving current flows, a light-emitting element driver which generates the driving current based on a pulse width modulation signal, and a pulse width modulator which generates the pulse width modulation signal based on first to k^{th} data bits. The pulse width modulator includes a data writer which writes the first to k^{th} data bits in response to a scan signal, a pulse width modulation controller which stores the first to k^{th} data bits and sequentially outputs the first to k^{th} data bits in response to a clock signal, and a pulse width modulation signal generator which generates the pulse width modulation signal in response to the first to k^{th} data bits and an emission signal.

This application claims priority to Korean Patent Application No. 10-2024-0073409, filed on Jun. 5, 2024, and all the benefits accruing therefrom under 35 U.S.C. § 119, the content of which in its entirety is herein incorporated by reference.

### BACKGROUND

### 1. Field

Embodiments relate to a display device. More particularly, embodiments relate to a pixel driven by a pulse width modulation method, a display device including the pixel, and an electronic apparatus including the display device.

### 2. Description of the Related Art

A display device may include a plurality of pixels, and each of the pixels may include a self-luminous element. The self-luminous element may include an organic light-emitting diode, a quantum dot light-emitting diode, a micro light-emitting diode, etc.

Generally, the organic light-emitting diode may be driven by a pulse amplitude modulation (“PAM”) method that controls a luminance of light emitted from a pixel by controlling an amplitude of a driving current flowing through the organic light-emitting diode.

When the micro light-emitting diode is driven by the pulse amplitude modulation method, a wavelength of light emitted from the micro light-emitting diode may shift depending on an amplitude of a driving current flowing through the micro light-emitting diode. Accordingly, the micro light-emitting diode may be driven by a pulse width modulation (“PWM”) method that controls the luminance of the light emitted from the pixel by controlling an emission time duration of the micro light-emitting diode while maintaining the amplitude of the driving current flowing through the micro light-emitting diode to be constant.

### SUMMARY

Embodiments provide a pixel which accurately represents a grayscale.

Embodiments provide a display device with improved display quality and an electronic apparatus including the display device.

A pixel in an embodiment of the disclosure includes a light-emitting element through which a driving current flows, a light-emitting element driver which generates the driving current based on a pulse width modulation signal, and a pulse width modulator which generates the pulse width modulation signal based on first to k^{th} data bits, where k is a natural number greater than 2. The pulse width modulator includes a data writer which writes the first to k^{th} data bits in response to a scan signal, a pulse width modulation controller which stores the first to k^{th} data bits and sequentially outputs the first to k^{th} data bits in response to a clock signal, and a pulse width modulation signal generator which generates the pulse width modulation signal in response to the first to k^{th} data bits and an emission signal.

In an embodiment, the pulse width modulation controller may include first to k^{th} flip-flops which shift the first to k^{th} data bits in response to the clock signal, and first to k^{th} connection transistors which connect the first to k^{th} flip-flops in response to the scan signal.

In an embodiment, the first to k^{th} data bits may be written to the first to k^{th} flip-flops at a rising edge or a falling edge of the clock signal within an activation period of the scan signal.

In an embodiment, the first to k^{th} data bits may be shifted between the first to k^{th} flip-flops at a rising edge or a falling edge of the clock signal within an activation period of the emission signal.

In an embodiment, an emission length corresponding to each of the first and k^{th} data bits may be an interval between a rising edge or a falling edge of the emission signal and a rising edge or a falling edge of the clock signal neighboring (adjacent to) the rising edge or the falling edge of the emission signal.

In an embodiment, an emission length corresponding to each of the second to k−1^{th} data bits may be an interval between neighboring pulses of the clock signal.

In an embodiment, each of the first to k^{th} connection transistors may be one of an n-channel metal-oxide-semiconductor (“NMOS”) transistor, a p-channel metal-oxide-semiconductor (“PMOS”) transistor, and a complementary metal-oxide-semiconductor (“CMOS”) transistor.

In an embodiment, the data writer may include first to k^{th} writing transistors which write the first to k^{th} data bits to the first to k^{th} flip-flops in response to the scan signal.

In an embodiment, each of the first to k^{th} writing transistors may be one of an NMOS transistor, a PMOS transistor, and a CMOS transistor.

In an embodiment, the pulse width modulation signal generator may include a logic gate which generates the pulse width modulation signal in response to a k^{th} output signal or a k^{th} inverted output signal output from the k^{th} flip-flop and the emission signal.

In an embodiment, the logic gate may be one of a NAND gate, an OR gate, a NOR gate, and an AND gate.

In an embodiment, the pulse width modulation signal generator may further include a level shifter which changes a voltage level of the pulse width modulation signal.

In an embodiment, the light-emitting element driver may include an emission transistor which forms a current path of the driving current in response to the pulse width modulation signal, and a current source which controls an amplitude of the driving current.

In an embodiment, the emission transistor may be one of a PMOS transistor and an NMOS transistor.

In an embodiment, the emission transistor may be connected to a line which transmits an emission high voltage, the light-emitting element may be connected to a line which transmits an emission low voltage, and the current source may be connected between the emission transistor and the light-emitting element.

In an embodiment, the light-emitting element may be connected to a line which transmits an emission high voltage, the emission transistor may be connected to a line which transmits an emission low voltage, and the current source may be connected between the light-emitting element and the emission transistor.

A display device may include a display panel including pixels, a data driver which provides first to k^{th} data bits corresponding to a grayscale to each of the pixels, where k is a natural number greater than 2, and a gate driver which provides scan signals, clock signals, and emission signals to the pixels. Each of the pixels may include a light-emitting element through which a driving current flows, a light-emitting element driver which generates the driving current based on a pulse width modulation signal, and a pulse width modulator which generates the pulse width modulation signal based on the first to k^{th} data bits. The pulse width modulator may include a data writer which writes the first to k^{th} data bits in response to a scan signal of the scan signals, a pulse width modulation controller which stores the first to k^{th} data bits and sequentially outputs the first to k^{th} data bits in response to a clock signal of the clock signals, and a pulse width modulation signal generator which generates the pulse width modulation signal in response to the first to k^{th} data bits and an emission signal of the emission signals.

In an embodiment, each of the scan signals, the clock signals, and the emission signals may be sequentially provided to pixel rows of the display panel at horizontal time intervals.

In an embodiment, the scan signals may be sequentially provided to pixel rows of the display panel at horizontal time intervals, and each of the clock signals and the emission signals may be simultaneously provided to the pixel rows.

In an embodiment, the pulse width modulator may generate the pulse width modulation signal based on the first to k^{th} data bits stored in the pulse width modulation controller without rewriting the first to k^{th} data bits when the display panel displays a still image.

In an electronic apparatus including a display device which displays an image and a processor which controls the display device in an embodiment of the disclosure, the display device includes a display panel including pixels, a data driver which provides first to k^{th} data bits corresponding to a grayscale to each of the pixels, where k is a natural number greater than 2, and a gate driver which provides scan signals, clock signals, and emission signals to the pixels. Each of the pixels includes a light-emitting element through which a driving current flows, a light-emitting element driver which generates the driving current based on a pulse width modulation signal, and a pulse width modulator which generates the pulse width modulation signal based on the first to k^{th} data bits. The pulse width modulator includes a data writer which writes the first to k^{th} data bits in response to a scan signal of the scan signals, a pulse width modulation controller which stores the first to k^{th} data bits and sequentially outputs the first to k^{th} data bits in response to a clock signal of the clock signals, and a pulse width modulation signal generator which generates the pulse width modulation signal in response to the first to k^{th} data bits and an emission signal of the emission signals.

In the pixel in the embodiment, the pulse width modulator may generate the pulse width modulation signal using a digital logic, and thus, a pulse width of the driving current flowing through the light-emitting element may be accurately controlled, and the pixel may accurately represent the grayscale. Further, in the display device and the electronic apparatus in the embodiments, each of the pixels may accurately represent the grayscale, and thus, the display quality of the display device may be improved.

### BRIEF DESCRIPTION OF THE DRAWINGS

Illustrative, non-limiting embodiments will be more clearly understood from the following detailed description taken in conjunction with the accompanying drawings.

FIG. 1 is a circuit diagram showing an embodiment of a pixel.

FIG. 2 is a timing diagram showing signals of the pixel of FIG. 1.

FIG. 3 is a circuit diagram showing an embodiment of a pixel.

FIG. 4 is a circuit diagram showing an embodiment of a pixel.

FIG. 5 is a circuit diagram showing an embodiment of a pixel.

FIG. 6 is a circuit diagram showing an embodiment of a pixel.

FIG. 7 is a circuit diagram showing an embodiment of a pixel.

FIG. 8 is a circuit diagram showing an embodiment of a pixel.

FIG. 9 is a circuit diagram showing an embodiment of a light-emitting element and a light-emitting element driver.

FIG. 10 is a circuit diagram showing an embodiment of a pixel.

FIG. 11 is a circuit diagram showing an embodiment of a pixel.

FIG. 12 is a circuit diagram showing an embodiment of a pixel.

FIG. 13 is a circuit diagram showing an embodiment of a pixel.

FIG. 14 is a circuit diagram showing an embodiment of a pixel.

FIG. 15 is a circuit diagram showing an embodiment of a pixel.

FIG. 16 is a circuit diagram showing an embodiment of a pixel.

FIG. 17 is a circuit diagram showing an embodiment of a light-emitting element and a light-emitting element driver.

FIG. 18 is a circuit diagram showing an embodiment of a pixel.

FIG. 19 is a block diagram showing an embodiment of a display device.

FIG. 20 is a block diagram showing an embodiment of an electronic apparatus.

FIG. 21 is a diagram showing an embodiment in which the electronic apparatus of FIG. 20 is implemented as a smart watch.

### DETAILED DESCRIPTION

Hereinafter, a pixel, a display device, and an electronic apparatus in embodiments of the disclosure will be described in more detail with reference to the accompanying drawings. The same or similar reference numerals will be used for the same elements in the accompanying drawings.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” may, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” may mean within one or more standard deviations, or within +30%, 20%, 10%, 5% of the stated value, for example.

The terms such as “writer,” “controller,” “signal generator” and “shifter” as used herein are intended to mean a hardware component such as a circuitry that performs a predetermined function. The hardware component may include a field-programmable gate array (“FPGA”) or an application-specific integrated circuit (“ASIC”), for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

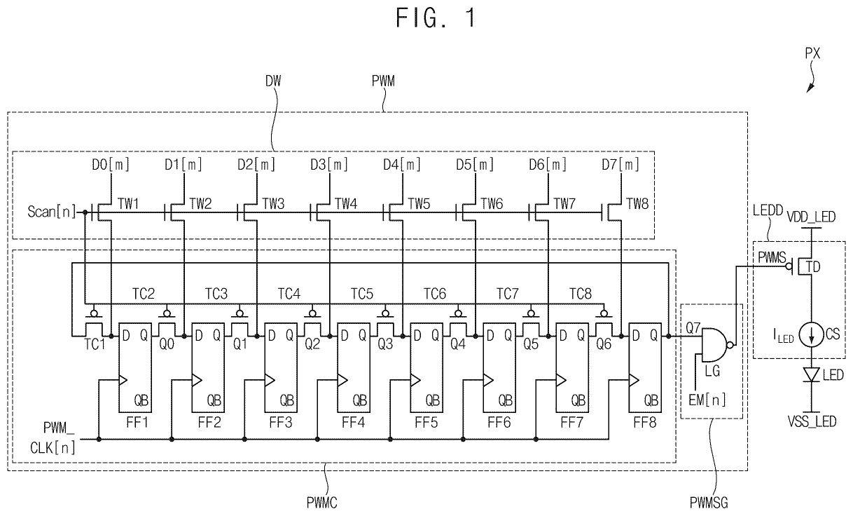

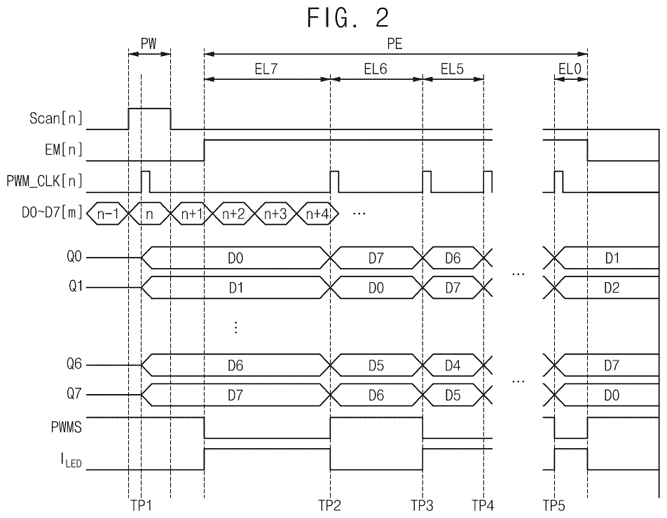

FIG. 1 is a circuit diagram showing an embodiment of a pixel PX. FIG. 2 is a timing diagram showing signals of the pixel PX of FIG. 1. In an embodiment, FIGS. 1 and 2 may represent a pixel PX disposed in an nth pixel row and an m^{th} pixel column and signals provided to the pixel PX, for example. Here, n and m are natural numbers.

Referring to FIGS. 1 and 2, a pixel PX may include a light-emitting element LED, a light-emitting element driver LEDD, and a pulse width modulator PWM.

A driving current I_{LED} may flow through the light-emitting element LED. The light-emitting element LED may emit light with a luminance corresponding to an amplitude of the driving current I_{LED} and a pulse width of the driving current I_{LED}. In an embodiment, the light-emitting element LED may be one of a micro light-emitting diode, an organic light-emitting diode, an inorganic light-emitting diode, and a quantum dot light-emitting diode.

The light-emitting element driver LEDD may generate the driving current I_{LED} based on a pulse width modulation signal PWMS. The light-emitting element driver LEDD may include an emission transistor TD and a current source CS.

The emission transistor TD may form a current path of the driving current I_{LED} in response to the pulse width modulation signal PWMS. The current path of the driving current I_{LED} may be formed in a direction from an emission high voltage VDD_LED to an emission low voltage VSS_LED. A voltage level of the emission high voltage VDD_LED may be higher than a voltage level of the emission low voltage VSS_LED. The emission transistor TD may be one of a p-channel metal oxide semiconductor (“PMOS”) transistor and an n-channel metal oxide semiconductor (“NMOS”) transistor.

The current source CS may control the amplitude of the driving current I_{LED}. The current source CS may generate the driving current I_{LED} having a constant amplitude.

In an embodiment, the emission transistor TD may be connected to a line transmitting the emission high voltage VDD_LED, the light-emitting element LED may be connected to a line transmitting the emission low voltage VSS_LED, and the current source CS may be connected between the emission transistor TD and the light-emitting element LED. In this case, the emission transistor TD may include a gate receiving the pulse width modulation signal PWMS, a first electrode receiving the emission high voltage VDD_LED, and a second electrode, the light-emitting element LED may include a first electrode (e.g., an anode) and a second electrode (e.g., a cathode) receiving the emission low voltage VSS_LED, and the current source CS may include a first terminal connected to the second electrode of the emission transistor TD and a second terminal connected to the first electrode of the light-emitting element LED.

The pulse width modulator PWM may control the pulse width of the driving current I_{LED}. The pulse width modulator PWM may generate the pulse width modulation signal PWMS based on first to k^{th} data bits (k is a natural number greater than 2). The first to k^{th} data bits may represent a grayscale of image data. The data bits may have a value of 0 or 1. In an embodiment, a data bit of 0 may correspond to a logic low level, and a data bit of 1 may correspond to a logic high level, for example.

In an embodiment, the k^{th} data bit may be a most significant bit (“MSB”), and the first data bit may be a least significant bit (“LSB”). However, the disclosure is not limited thereto, and the MSB may be one of the first to k−1^{th} data bits, and the LSB may be one of the second to k^{th} data bits.

Hereinafter, it is described that the grayscale has a grayscale range of 0 to 255 (i.e., k is 8).

The pulse width modulator PWM may include a pulse width modulation controller PWMC, a data writer DW, and a pulse width modulation signal generator PWMSG.

The pulse width modulation controller PWMC may store first to eighth data bits D0[m] to D7[m], and may sequentially output the first to eighth data bits D0[m] to D7[m] in response to a clock signal PWM_CLK[n]. The pulse width modulation controller PWMC may include first to eighth flip-flops FF1 to FF8 and first to eighth connection transistors TC1 to TC8.

The first to eighth connection transistors TC1 to TC8 may connect the first to eighth flip-flops FF1 to FF8 in response to a scan signal Scan[n]. The first connection transistor TC1 may be arranged between the eighth flip-flop FF8 and the first flip-flop FF1, the second connection transistor TC2 may be arranged between the first flip-flop FF1 and the second flip-flop FF2, the third connection transistor TC3 may be arranged between the second flip-flop FF2 and the third flip-flop FF3, the fourth connection transistor TC4 may be arranged between the third flip-flop FF3 and the fourth flip-flop FF4, the fifth connection transistor TC5 may be arranged between the fourth flip-flop FF4 and the fifth flip-flop FF5, the sixth connection transistor TC6 may be arranged between the fifth flip-flop FF5 and the sixth flip-flop FF6, the seventh connection transistor TC7 may be arranged between the sixth flip-flop FF6 and the seventh flip-flop FF7, and the eighth connection transistor TC8 may be arranged between the seventh flip-flop FF7 and the eighth flip-flop FF8. Each of the first to eighth connection transistors TC1 to TC8 may be one of an n-channel metal-oxide-semiconductor (“NMOS”) transistor, a p-channel metal-oxide-semiconductor (“PMOS”) transistor, and a complementary metal oxide semiconductor (“CMOS”) transistor.

The first to eighth flip-flops FF1 to FF8 may shift the first to eighth data bits D0[m] to D7[m] in response to the clock signal PWM_CLK[n]. In a state in which the first to eighth connection transistors TC1 to TC8 are turned on in response to the scan signal Scan[n], the first to eighth data bits D0[m] to D7[m] may be shifted in a direction from the first flip-flop FF1 toward the eighth flip-flop FF8 in response to pulses of the clock signal PWM_CLK[n].

In an embodiment, each of the first to eighth flip-flops FF1 to FF8 may be a D flip-flop. In this case, each of the first to eighth flip-flops FF1 to FF8 may output an output signal Q that is the same as an input data bit D input in response to the pulse of the clock signal PWM_CLK[n] and an inverted output signal QB that is an inverted signal of the output signal Q. In an embodiment, each of the first to eighth flip-flops FF1 to FF8 may output 1 and 0 as the output signal Q and the inverted output signal QB, respectively, when the input data bit Dis 1, and may output 0 and 1 as the output signal Q and the inverted output signal QB, respectively, when the input data bit D is 0, for example.

The data writer DW may write the first to eighth data bits D0[m] to D7[m] in response to the scan signal Scan[n]. The data writer DW may include first to eighth writing transistors TW1 to TW8. The first to eighth writing transistors TW1 to TW8 may write the first to eighth data bits D0[m] to D7[m] to the first to eighth flip-flops FF1 to FF8 in response to the scan signal Scan[n]. Each of the first to eighth writing transistors TW1 to TW8 may be one of an NMOS transistor, a PMOS transistor, and a CMOS transistor.

The pulse width modulation signal generator PWMSG may generate the pulse width modulation signal PWMS in response to the first to eighth data bits D0[m] to D7[m] and an emission signal EM[n].

The pulse width modulation signal generator PWMSG may include a logic gate LG. The logic gate LG may generate the pulse width modulation signal PWMS in response to an eighth output signal Q7 or an eighth inverted output signal QB7 output from the eighth flip-flop FF8, and the emission signal EM[n]. The logic gate LG may be one of a NAND gate, an OR gate, a NOR gate, and an AND gate.

The first to eighth data bits D0[m] to D7[m] may be written to the first to eighth flip-flops FF1 to FF8 at a rising edge or a falling edge of the clock signal PWM_CLK[n] within an activation period PW of the scan signal Scan[n]. The activation period PW of the scan signal Scan[n] may be a period in which the scan signal Scan[n] has an activation level. In an embodiment, as illustrated in FIG. 2, the first to eighth data bits D0[m] to D7[m] may be written to the first to eighth flip-flops FF1 to FF8 at the rising edge of the clock signal PWM_CLK[n] within the activation period PW of the scan signal Scan[n]. In this case, the first to eighth output signals Q1 to Q7 may be the first to eighth data bits D0[m] to D7[m], respectively, from a first time point TP1 to a second time point TP2. However, the disclosure is not limited thereto, and in another embodiment, the first to eighth data bits D0[m] to D7[m] may be written to the first to eighth flip-flops FF1 to FF8 at the falling edge of the clock signal PWM_CLK[n] within the activation period PW of the scan signal Scan[n].

The first to eighth data bits D0[m] to D7[m] may be shifted between the first to eighth flip-flops FF1 to FF8 at the rising edge or the falling edge of the clock signal PWM_CLK[n] within an activation period PE of the emission signal EM[n]. The activation period PE of the emission signal EM[n] may be a period in which the emission signal EM[n] has an activation level. In an embodiment, as illustrated in FIG. 2, the first to eighth data bits D0[m] to D7[m] may be shifted between the first to eighth flip-flops FF1 to FF8 at the rising edge of the clock signal PWM_CLK[n] within the activation period PE of the emission signal EM[n]. In this case, the first to eighth output signals Q1 to Q7 may be the eighth and first to seventh data bits D7[m], D0[m] to D6[m], respectively, from the second time point TP2 to a third time point TP3, the first to eighth output signals Q1 to Q7 may be the seventh, eighth, and first to sixth data bits D6[m], D7[m], D0[m] to D5[m], respectively, from the third time point TP3 to a fourth time point TP4, and the first to eighth output signals Q1 to Q7 may be the second to eighth and first data bits D1[m] to D7[m], D0[m], respectively, from a fifth time point TP5.

Emission lengths corresponding to the first to eighth data bits D0[m] to D7[m] may be determined by controlling a rising edge and a falling edge of the emission signal EM[n] and the pulses of the clock signal PWM_CLK[n] within the activation period PE of the emission signal EM[n]. The emission lengths corresponding to the first to eighth data bits D0[m] to D7[m] may correspond to weights of the first to eighth data bits D0[m] to D7[m]. In an embodiment, when the eighth data bit D7[m] is the MSB and the first data bit D0[m] is the LSB, among the emission lengths corresponding to the first to eighth data bits D0[m] to D7[m], an eighth emission length EL7 corresponding to the eighth data bit D7[m] may be the largest, and a first emission length EL0 corresponding to the first data bit D0[m] may be the smallest, for example.

The emission length corresponding to each of the first and eighth data bits D0[m], D7[m] may be an interval between the rising edge or the falling edge of the emission signal EM[n] and the rising edge or the falling edge of the clock signal PWM_CLK[n] neighboring (adjacent to) the rising edge or the falling edge of the emission signal EM[n]. In an embodiment, as illustrated in FIG. 2, the eighth emission length EL7 corresponding to the eighth data bit D7[m] may be an interval between the rising edge of the emission signal EM[n] and the rising edge of the clock signal PWM_CLK[n] neighboring (adjacent to) the rising edge of the emission signal EM[n], and the first emission length EL0 corresponding to the first data bit D0[m] may be an interval between the falling edge of the emission signal EM[n] and the rising edge of the clock signal PWM_CLK[n] neighboring (adjacent to) the falling edge of the emission signal EM[n]. However, the disclosure is not limited thereto, and in another embodiment, in a case that the first to eighth data bits D0[m] to D7[m] are written to the first to eighth flip-flops FF1 to FF8 at the falling edge of the clock signal PWM_CLK[n], the eighth emission length EL7 corresponding to the eighth data bit D7[m] may be an interval between the rising edge of the emission signal EM[n] and the falling edge of the clock signal PWM_CLK[n] neighboring (adjacent to) the rising edge of the emission signal EM[n], and the first emission length EL0 corresponding to the first data bit D0[m] may be an interval between the falling edge of the emission signal EM[n] and the falling edge of the clock signal PWM_CLK[n] neighboring (adjacent to) the falling edge of the emission signal EM[n].

The emission length corresponding to each of the second to seventh data bits D1[m] to D6[m] may be intervals between neighboring pulses of the clock signal PWM_CLK[n]. In an embodiment, as illustrated in FIG. 2, a seventh emission length EL6 corresponding to the seventh data bit D6[m] may be an interval between a first pulse and a second pulse of the clock signal PWM_CLK[n] within the activation period PE of the emission signal EM[n], and a sixth emission length EL5 corresponding to the sixth data bit D5[m] may be an interval between the second pulse and a third pulse of the clock signal PWM_CLK[n] within the activation period PE of the emission signal EM[n].

The emission transistor TD may be turned on for a time duration corresponding to the sum of the emission lengths corresponding to the data bits having a logic level of 1 in response to the pulse width modulation signal PWMS, and the driving current I_{LED} having a pulse width corresponding to the sum of the emission lengths corresponding to the data bits having a logic level of 1 may flow through the light-emitting element LED. Accordingly, the pulse width of the driving current I_{LED} may be controlled by a grayscale indicated by the first to eighth data bits D0[m] to D7[m], and the light-emitting element LED may emit light with a luminance corresponding to the grayscale indicated by the first to eighth data bits D0[m] to D7[m].

In the pixel PX in the illustrated embodiment, each of the first to eighth writing transistors TW1 to TW8 may be an NMOS transistor, each of the first to eighth connection transistors TC1 to TC8 may be a PMOS transistor, the logic gate LG may be a NAND gate, and the emission transistor TD may be a PMOS transistor. Further, the activation level of the scan signal Scan[n] may be a logic high level, the first to eighth writing transistors TW1 to TW8 may be turned on in response to the activation level of the scan signal Scan[n], the first to eighth connection transistors TC1 to TC8 may be turned on in response to a deactivation level of the scan signal Scan[n], the logic gate LG may receive the eighth output signal Q7 from the eighth flip-flop FF8, and the activation level of the emission signal EM[n] may be a logic high level.

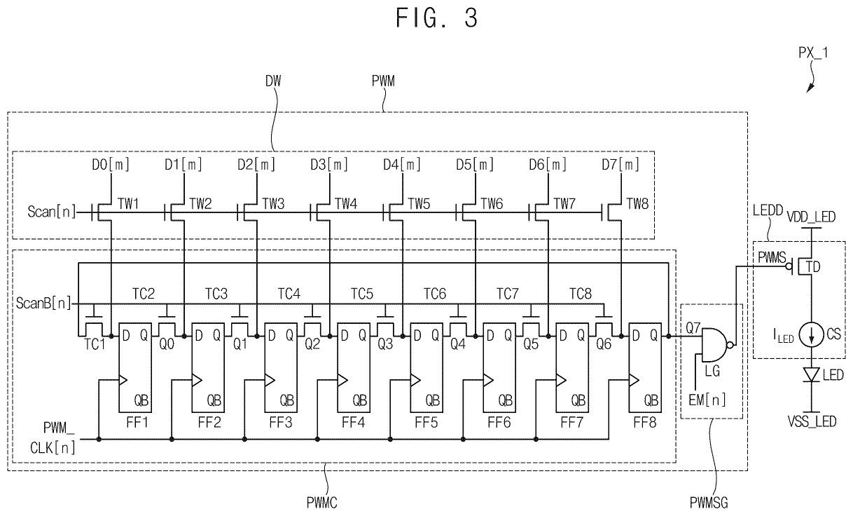

In the illustrated embodiment, the pulse width modulator PWM may generate the pulse width modulation signal PWMS using a digital logic including the first to eighth flip-flops FF1 to FF8, and thus, the pulse width of the driving current I_{LED} flowing through the light-emitting element LED may be accurately controlled, and the pixel PX may accurately represent the grayscale indicated by the first to eighth data bits D0[m] to D7[m]. FIG. 3 is a circuit diagram showing an embodiment of a pixel PX_1.

Descriptions of components of a pixel PX_1 described with reference to FIG. 3, which are substantially the same as or similar to those of the pixel PX described with reference to FIGS. 1 and 2, are omitted.

Referring to FIG. 3, in a pixel PX_1 in the illustrated embodiment, each of the first to eighth connection transistors TC1 to TC8 may be an NMOS transistor. Further, the first to eighth connection transistors TC1 to TC8 may be turned on in response to an activation level of an inverted scan signal ScanB[n]. The inverted scan signal ScanB[n] may be an inverted signal of the scan signal Scan[n].

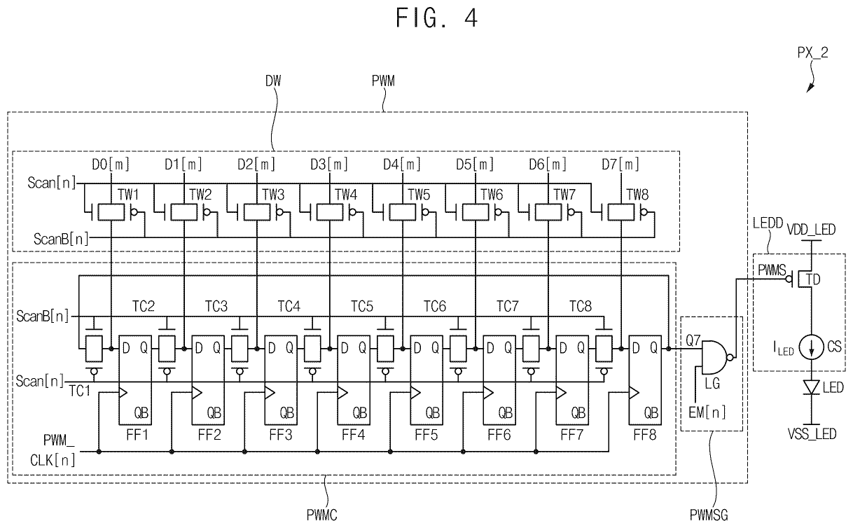

FIG. 4 is a circuit diagram showing an embodiment of a pixel PX_2.

Descriptions of components of a pixel PX_2 described with reference to FIG. 4, which are substantially the same as or similar to those of the pixel PX described with reference to FIGS. 1 and 2, are omitted.

Referring to FIG. 4, in a pixel PX_2 in the illustrated embodiment, each of the first to eighth writing transistors TW1 to TW8 may be a CMOS transistor, and each of the first to eighth connection transistors TC1 to TC8 may be a CMOS transistor. Further, the first to eighth writing transistors TW1 to TW8 may be turned on in response to the activation level of the scan signal Scan[n] and a deactivation level of an inverted scan signal ScanB[n], and the first to eighth connection transistors TC1 to TC8 may be turned on in response to an activation level of the inverted scan signal ScanB[n] and the deactivation level of the scan signal Scan[n]. The inverted scan signal ScanB[n] may be an inverted signal of the scan signal Scan[n].

In the pixel PX_2 in the illustrated embodiment, each of the first to eighth connection transistors TC1 to TC8 may be changed to a PMOS transistor similar to the pixel PX of FIG. 1, or may be changed to an NMOS transistor similar to the pixel PX_1 of FIG. 3. In the pixel PX_2 in the illustrated embodiment, each of the first to eighth writing transistors TW1 to TW8 may be changed to an NMOS transistor similar to the pixel PX of FIG. 1.

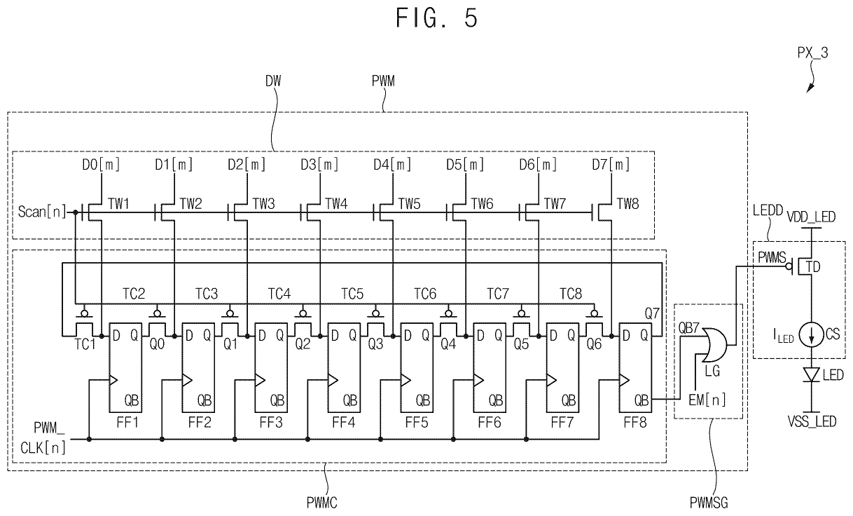

FIG. 5 is a circuit diagram showing an embodiment of a pixel PX_3.

Descriptions of components of a pixel PX_3 described with reference to FIG. 5, which are substantially the same as or similar to those of the pixel PX described with reference to FIGS. 1 and 2, are omitted.

Referring to FIG. 5, in a pixel PX_3 in the illustrated embodiment, the logic gate LG may be an OR gate. Further, the logic gate LG may receive the eighth inverted output signal QB7 from the eighth flip-flop FF8, and the activation level of the emission signal EM[n] may be a logic low level.

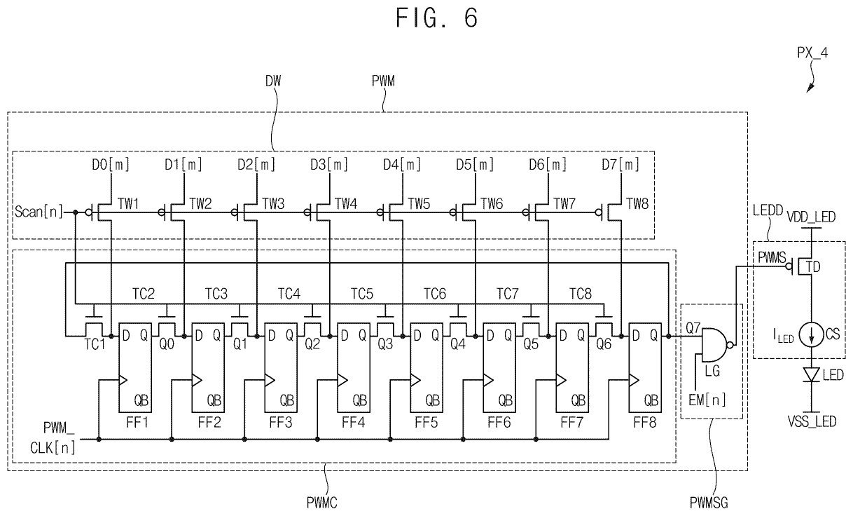

In the pixel PX_3 in the illustrated embodiment, each of the first to eighth connection transistors TC1 to TC8 may be changed to an NMOS transistor similar to the pixel PX_1 of FIG. 3. In the pixel PX_3 in the illustrated embodiment, each of the first to eighth writing transistors TW1 to TW8 may be changed to a CMOS transistor similar to the pixel PX_2 of FIG. 4. In the pixel PX_3 in the illustrated embodiment, each of the first to eighth connection transistors TC1 to TC8 may be changed to a CMOS transistor similar to the pixel PX_2 of FIG. 4. In the pixel PX_3 in the illustrated embodiment, each of the first to eighth writing transistors TW1 to TW8 and the first to eighth connection transistors TC1 to TC8 may be changed to a CMOS transistor similar to the pixel PX_2 of FIG. 4. FIG. 6 is a circuit diagram showing an embodiment of a pixel PX_4.

Descriptions of components of a pixel PX_4 described with reference to FIG. 6, which are substantially the same as or similar to those of the pixel PX described with reference to FIGS. 1 and 2, are omitted.

Referring to FIG. 6, in a pixel PX_4 in the illustrated embodiment, each of the first to eighth writing transistors TW1 to TW8 may be a PMOS transistor, and each of the first to eighth connection transistors TC1 to TC8 may be an NMOS transistor. Further, the activation level of the scan signal Scan[n] may be a logic low level. In a case that the activation level of the scan signal Scan[n] is a logic low level, the first to eighth writing transistors TW1 to TW8 may be turned on in response to the activation level of the scan signal Scan[n], and the first to eighth connection transistors TC1 to TC8 may be turned on in response to a deactivation level of the scan signal Scan[n].

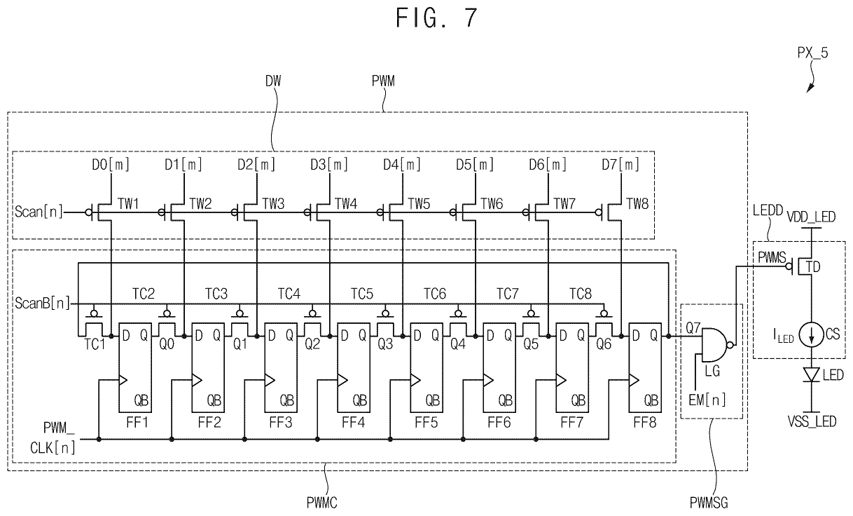

FIG. 7 is a circuit diagram showing an embodiment of a pixel PX_5.

Descriptions of components of a pixel PX_5 described with reference to FIG. 7, which are substantially the same as or similar to those of the pixel PX_4 described with reference to FIG. 6, are omitted.

Referring to FIG. 7, in a pixel PX_5 in the illustrated embodiment, each of the first to eighth connection transistors TC1 to TC8 may be a PMOS transistor. Further, the first to eighth connection transistors TC1 to TC8 may be turned on in response to an activation level of an inverted scan signal ScanB[n]. The inverted scan signal ScanB[n] may be an inverted signal of the scan signal Scan[n].

In the pixel PX_5 in the illustrated embodiment, each of the first to eighth writing transistors TW1 to TW8 may be changed to a CMOS transistor similar to the pixel PX_2 of FIG. 4. In the pixel PX_5 in the illustrated embodiment, each of the first to eighth connection transistors TC1 to TC8 may be changed to a CMOS transistor similar to the pixel PX_2 of FIG. 4. In the pixel PX_5 in the illustrated embodiment, each of the first to eighth writing transistors TW1 to TW8 and the first to eighth connection transistors TC1 to TC8 may be changed to a CMOS transistor similar to the pixel PX_2 of FIG. 4.

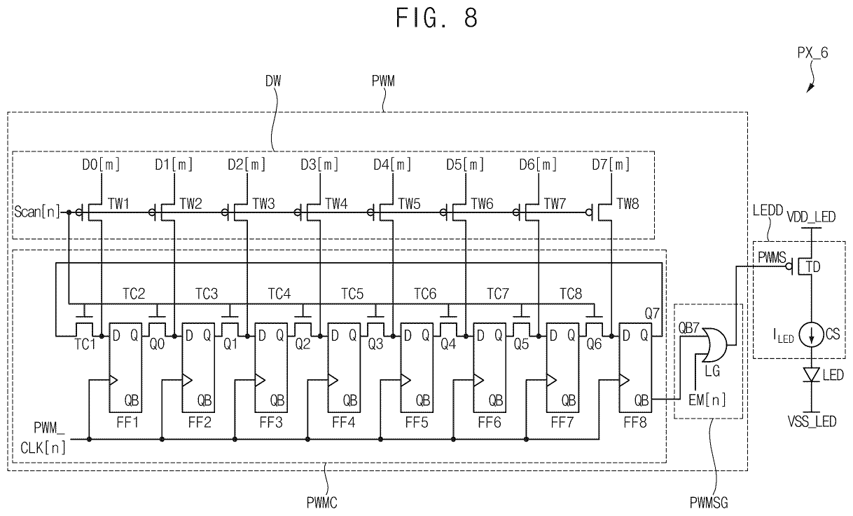

FIG. 8 is a circuit diagram showing an embodiment of a pixel PX_6.

Descriptions of components of a pixel PX_6 described with reference to FIG. 8, which are substantially the same as or similar to those of the pixel PX_4 described with reference to FIG. 6, are omitted.

Referring to FIG. 8, in a pixel PX_6 in the illustrated embodiment, the logic gate LG may be an OR gate. Further, the logic gate LG may receive the eighth inverted output signal QB7 from the eighth flip-flop FF8, and the activation level of the emission signal EM[n] may be a logic low level. In a case that the activation level of the scan signal Scan[n] is a logic low level, the first to eighth writing transistors TW1 to TW8 may be turned on in response to the activation level of the scan signal Scan[n], and the first to eighth connection transistors TC1 to TC8 may be turned on in response to a deactivation level of the scan signal Scan[n].

In the pixel PX_6 in the illustrated embodiment, each of the first to eighth connection transistors TC1 to TC8 may be changed to a PMOS transistor similar to the pixel PX of FIG. 1. In the pixel PX_6 in the illustrated embodiment, each of the first to eighth writing transistors TW1 to TW8 may be changed to a CMOS transistor similar to the pixel PX_2 of FIG. 4. In the pixel PX_6 in the illustrated embodiment, each of the first to eighth connection transistors TC1 to TC8 may be changed to a CMOS transistor similar to the pixel PX_2 of FIG. 4. In the pixel PX_6 in the illustrated embodiment, each of the first to eighth writing transistors TW1 to TW8 and the first to eighth connection transistors TC1 to TC8 may be changed to a CMOS transistor similar to the pixel PX_2 of FIG. 4.

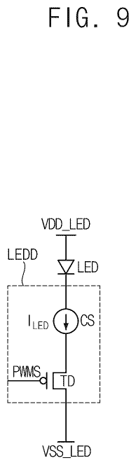

FIG. 9 is a circuit diagram showing an embodiment of a light-emitting element LED and a light-emitting element driver LEDD.

The connection relationship between the light-emitting element LED and the light-emitting element driver LEDD of FIG. 9 may be different from the connection relationship between the light-emitting element LED and the light-emitting element driver LEDD of FIGS. 1, 3 to 8.

Referring to FIG. 9, in an embodiment, the light-emitting element LED may be connected to a line transmitting the emission high voltage VDD_LED, the emission transistor TD may be connected to a line transmitting the emission low voltage VSS_LED, and the current source CS may be connected between the light-emitting element LED and the emission transistor TD. In this case, the emission transistor TD may include a gate receiving the pulse width modulation signal PWMS, a first electrode, and a second electrode receiving the emission low voltage VSS_LED, the light-emitting element LED may include a first electrode (e.g., an anode) receiving the emission high voltage VDD_LED and a second electrode (e.g., a cathode), and the current source CS may include a first terminal connected to the second electrode of the light-emitting element LED and a second terminal connected to the first electrode of the emission transistor TD.

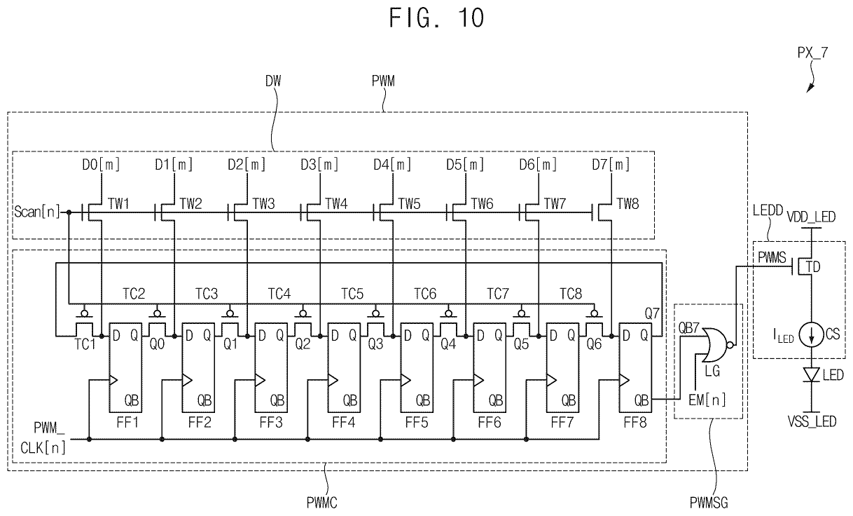

FIG. 10 is a circuit diagram showing an embodiment of a pixel PX_7.

Descriptions of components of a pixel PX_7 described with reference to FIG. 10, which are substantially the same as or similar to those of the pixel PX described with reference to FIGS. 1 and 2, are omitted.

Referring to FIG. 10, in a pixel PX_7 in the illustrated embodiment, the logic gate LG may be a NOR gate, and the emission transistor TD may be an NMOS transistor. Further, the logic gate LG may receive the eighth inverted output signal QB7 from the eighth flip-flop FF8, and the activation level of the emission signal EM[n] may be a logic low level.

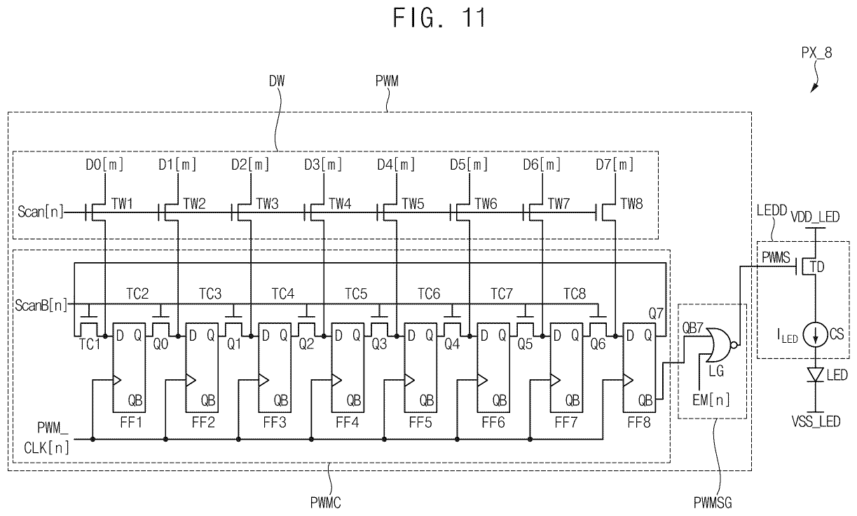

FIG. 11 is a circuit diagram showing an embodiment of a pixel PX_8.

Descriptions of components of a pixel PX_8 described with reference to FIG. 11, which are substantially the same as or similar to those of the pixel PX_7 described with reference to FIG. 10, are omitted.

Referring to FIG. 11, in a pixel PX_8 in the illustrated embodiment, each of the first to eighth connection transistors TC1 to TC8 may be an n-channel metal-oxide-semiconductor (“NMOS”) transistor. Further, the first to eighth connection transistors TC1 to TC8 may be turned on in response to an activation level of an inverted scan signal ScanB[n]. The inverted scan signal ScanB[n] may be an inverted signal of the scan signal Scan[n].

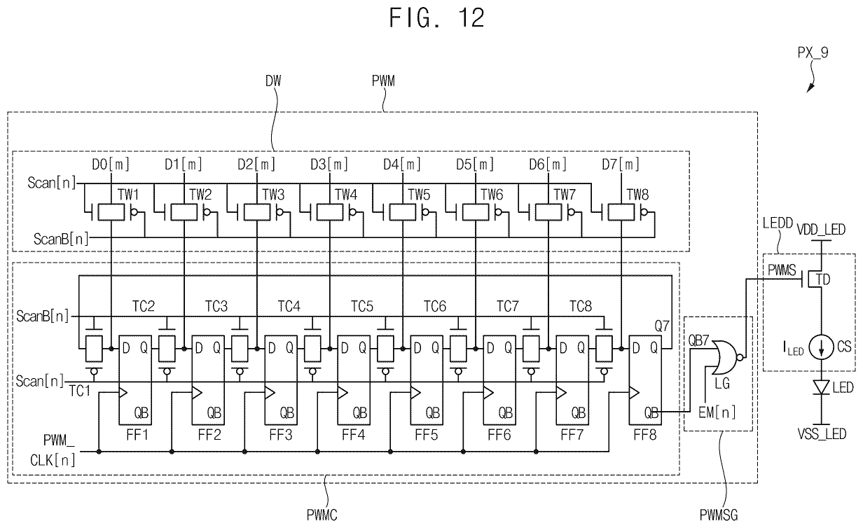

FIG. 12 is a circuit diagram showing an embodiment of a pixel PX_9.

Descriptions of components of a pixel PX_9 described with reference to FIG. 12, which are substantially the same as or similar to those of the pixel PX_7 described with reference to FIG. 10, are omitted.

Referring to FIG. 12, in a pixel PX_9 in the illustrated embodiment, each of the first to eighth writing transistors TW1 to TW8 may be a CMOS transistor, and each of the first to eighth connection transistors TC1 to TC8 may be a CMOS transistor. Further, the first to eighth writing transistors TW1 to TW8 may be turned on in response to the activation level of the scan signal Scan[n] and an deactivation level of an inverted scan signal ScanB[n], and the first to eighth connection transistors TC1 to TC8 may be turned on in response to an activation level of the inverted scan signal ScanB[n] and the deactivation level of the scan signal Scan[n]. The inverted scan signal ScanB[n] may be an inverted signal of the scan signal Scan[n].

In the pixel PX_9 in the illustrated embodiment, each of the first to eighth connection transistors TC1 to TC8 may be changed to a PMOS transistor similar to the pixel PX_7 of FIG. 10, or may be changed to an NMOS transistor similar to the pixel PX_8 of FIG. 11. In the pixel PX_9 in the illustrated embodiment, each of the first to eighth writing transistors TW1 to TW8 may be changed to an NMOS transistor similar to the pixel PX_7 of FIG. 10.

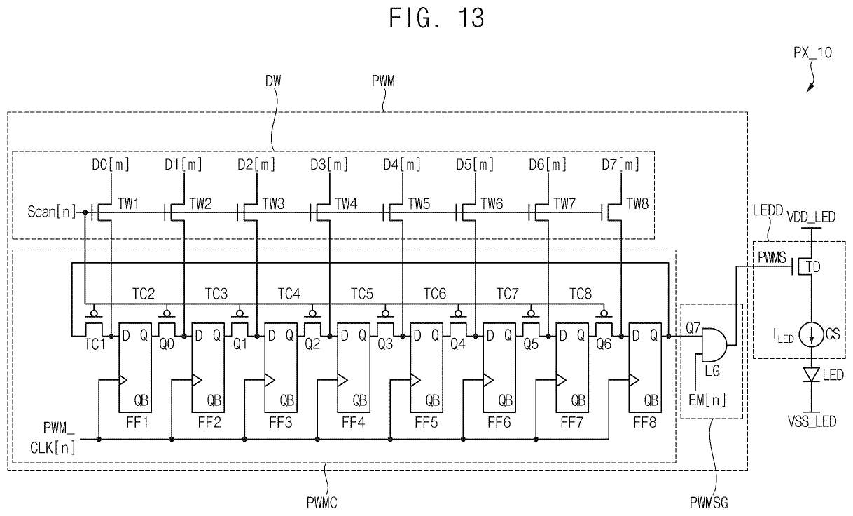

FIG. 13 is a circuit diagram showing an embodiment of a pixel PX_10.

Descriptions of components of a pixel PX_10 described with reference to FIG. 13, which are substantially the same as or similar to those of the pixel PX_7 described with reference to FIG. 10, are omitted.

Referring to FIG. 13, in a pixel PX_10 in the illustrated embodiment, the logic gate LG may be an AND gate. Further, the logic gate LG may receive the eighth output signal Q7 from the eighth flip-flop FF8, and the activation level of the emission signal EM[n] may be a logic high level.

In the pixel PX_10 in the illustrated embodiment, each of the first to eighth connection transistors TC1 to TC8 may be changed to an NMOS transistor similar to the pixel PX_8 of FIG. 11. In the pixel PX_10 in the illustrated embodiment, each of the first to eighth writing transistors TW1 to TW8 may be changed to a CMOS transistor similar to the pixel PX_9 of FIG. 12. In the pixel PX_10 in the illustrated embodiment, each of the first to eighth connection transistors TC1 to TC8 may be changed to a CMOS transistor similar to the pixel PX_9 of FIG. 12. In the pixel PX_10 in the illustrated embodiment, each of the first to eighth writing transistors TW1 to TW8 and the first to eighth connection transistors TC1 to TC8 may be changed to a CMOS transistor similar to the pixel PX_9 of FIG. 12.

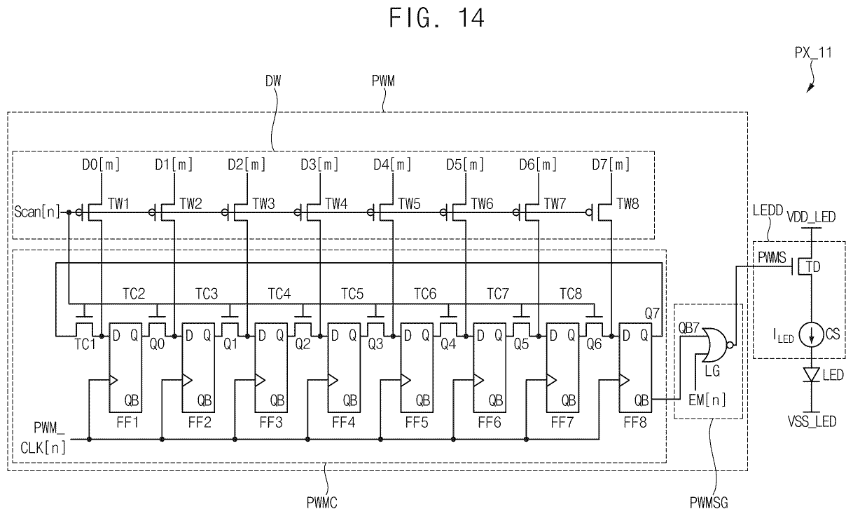

FIG. 14 is a circuit diagram showing an embodiment of a pixel PX_11.

Descriptions of components of a pixel PX_11 described with reference to FIG. 14, which are substantially the same as or similar to those of the pixel PX_7 described with reference to FIG. 10, are omitted.

Referring to FIG. 14, in a pixel PX_11 in the illustrated embodiment, each of the first to eighth writing transistors TW1 to TW8 may be a PMOS transistor, and each of the first to eighth connection transistors TC1 to TC8 may be an NMOS transistor. Further, the activation level of the scan signal Scan[n] may be a logic low level. In a case that the activation level of the scan signal Scan[n] is a logic low level, the first to eighth writing transistors TW1 to TW8 may be turned on in response to the activation level of the scan signal Scan[n], and the first to eighth connection transistors TC1 to TC8 may be turned on in response to a deactivation level of the scan signal Scan[n].

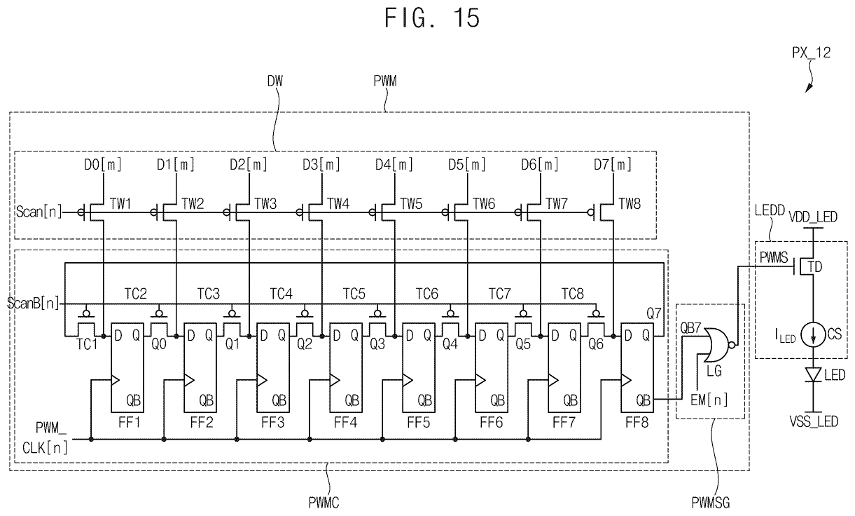

FIG. 15 is a circuit diagram showing an embodiment of a pixel PX_12.

Descriptions of components of a pixel PX_12 described with reference to FIG. 15, which are substantially the same as or similar to those of the pixel PX_11 described with reference to FIG. 14, are omitted.

Referring to FIG. 15, in a pixel PX_12 in the illustrated embodiment, each of the first to eighth connection transistors TC1 to TC8 may be a PMOS transistor. Further, the first to eighth connection transistors TC1 to TC8 may be turned on in response to an activation level of an inverted scan signal ScanB[n]. The inverted scan signal ScanB[n] may be an inverted signal of the scan signal Scan[n].

In the pixel PX_12 in the illustrated embodiment, each of the first to eighth writing transistors TW1 to TW8 may be changed to a CMOS transistor similar to the pixel PX_9 of FIG. 12. In the pixel PX_12 in the illustrated embodiment, each of the first to eighth connection transistors TC1 to TC8 may be changed to a CMOS transistor similar to the pixel PX_9 of FIG. 12. In the pixel PX_12 in the illustrated embodiment, each of the first to eighth writing transistors TW1 to TW8 and the first to eighth connection transistors TC1 to TC8 may be changed to a CMOS transistor similar to the pixel PX_9 of FIG. 12.

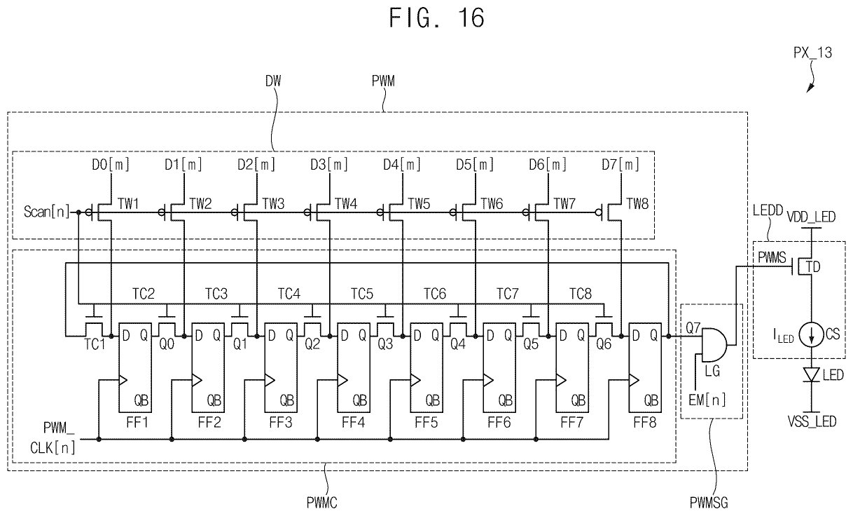

FIG. 16 is a circuit diagram showing a pixel PX_13.

Descriptions of components of a pixel PX_13 described with reference to FIG. 16, which are substantially the same as or similar to those of the pixel PX_11 described with reference to FIG. 14, are omitted.

Referring to FIG. 16, in a pixel PX_13 in the illustrated embodiment, the logic gate LG may be an AND gate. Further, the logic gate LG may receive the eighth output signal Q7 from the eighth flip-flop FF8, and the activation level of the emission signal EM[n] may be a logic high level.

In the pixel PX_13 in the illustrated embodiment, each of the first to eighth connection transistors TC1 to TC8 may be changed to a PMOS transistor similar to the pixel PX_7 of FIG. 10. In the pixel PX_13 in the illustrated embodiment, each of the first to eighth writing transistors TW1 to TW8 may be changed to a CMOS transistor similar to the pixel PX_9 of FIG. 12. In the pixel PX_13 in the illustrated embodiment, each of the first to eighth connection transistors TC1 to TC8 may be changed to a CMOS transistor similar to the pixel PX_9 of FIG. 12. In the pixel PX_13 in the illustrated embodiment, each of the first to eighth writing transistors TW1 to TW8 and the first to eighth connection transistors TC1 to TC8 may be changed to a CMOS transistor similar to the pixel PX_9 of FIG. 12.

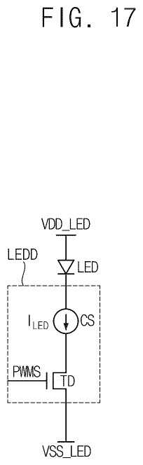

FIG. 17 is a circuit diagram showing an embodiment of a light-emitting element LED and a light-emitting element driver LEDD.

The connection relationship between the light-emitting element LED and the light-emitting element driver LEDD of FIG. 17 may be different from the connection relationship between the light-emitting element LED and the light-emitting element driver LEDD of FIGS. 10 to 16.

Referring to FIG. 17, in an embodiment, the light-emitting element LED may be connected to a line transmitting the emission high voltage VDD_LED, the emission transistor TD may be connected to a line transmitting the emission low voltage VSS_LED, and the current source CS may be connected between the light-emitting element LED and the emission transistor TD. In this case, the emission transistor TD may include a gate receiving the pulse width modulation signal PWMS, a first electrode, and a second electrode receiving the emission low voltage VSS_LED, the light-emitting element LED may include a first electrode (e.g., an anode) receiving the emission high voltage VDD_LED and a second electrode (e.g., a cathode), and the current source CS may include a first terminal connected to the second electrode of the light-emitting element LED and a second terminal connected to the first electrode of the emission transistor TD.

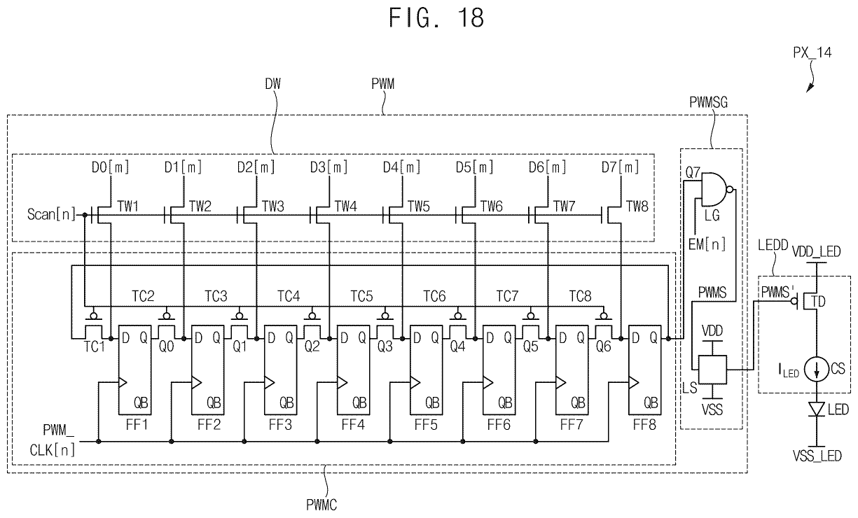

FIG. 18 is a circuit diagram showing an embodiment of a pixel PX_14.

Descriptions of components of a pixel PX_14 described with reference to FIG. 18, which are substantially the same as or similar to those of the pixel PX described with reference to FIGS. 1 and 2, are omitted.

Referring to FIG. 18, the pulse width modulation signal generator PWMSG may further include a level shifter LS. The level shifter LS may change a voltage level of the pulse width modulation signal PWMS. The level shifter LS may increase or decrease the voltage level of the pulse width modulation signal PWMS output from the logic gate LG based on a low voltage VSS and a high voltage VDD in order to output a compensation pulse width modulation signal PWMS′. A voltage level of the high voltage VDD may be higher than a voltage level of the low voltage VSS.

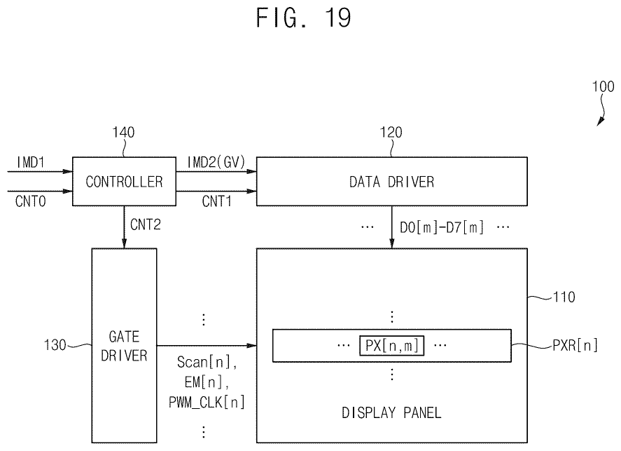

FIG. 19 is a block diagram showing an embodiment of a display device 100.

Referring to FIG. 19, a display device 100 may include a display panel 110, a data driver 120, a gate driver 130, and a controller 140.

The display panel 110 may include pixels PX. The pixel PX[n,m] illustrated in FIG. 19 may correspond to the pixel PX of FIG. 1, the pixel PX_1 of FIG. 3, the pixel PX_2 of FIG. 4, the pixel PX_3 of FIG. 5, the pixel PX_4 of FIG. 6, the pixel PX_5 of FIG. 7, the pixel PX_6 of FIG. 8, the pixel PX_7 of FIG. 10, the pixel PX_8 of FIG. 11, the pixel PX_9 of FIG. 12, the pixel PX_10 of FIG. 13, the pixel PX_11 of FIG. 14, the pixel PX_12 of FIG. 15, the pixel PX_13 of FIG. 16, or the pixel PX_14 of FIG. 18.

The data driver 120 may provide the first to eighth data bits D0-D7 corresponding to a grayscale of second image data IMD2 to each of the pixels PX. The data driver 120 may generate the first to eighth data bits D0-D7 based on the grayscale of the second image data IMD2 and a first control signal CNT1. The data driver 120 may provide one first to eighth data bit D0-D7 to one pixel column. In an embodiment, the data driver 120 may provide an m^{th} first to eighth data bits D0[m] to D7[m] to an m^{th} pixel column, for example.

The gate driver 130 may provide scan signals Scan, clock signals PWM_CLK, and emission signals EM to the pixels PX. The gate driver 130 may generate the scan signals Scan, the clock signals PWM_CLK, and the emission signals EM based on a second control signal CNT2. The gate driver 130 may provide one scan signal Scan, one clock signal PWM_CLK, and one emission signal EM to one pixel row PXR. In an embodiment, the gate driver 130 may provide an n^{th} scan signal Scan[n], an n^{th} clock signal PWM_CLK[n], and an n^{th} emission signal EM[n] to an n^{th} pixel row PXR[n], for example.

The scan signals Scan may be sequentially provided to the pixel rows PXR at horizontal time intervals. In an embodiment, the n^{th} scan signal Scan[n] provided to the n^{th} pixel row PXR[n] may be a signal that is shifted by n−1 horizontal time durations from the first scan signal provided to the first pixel row, for example.

In an embodiment, each of the clock signals PWM_CLK and the emission signals EM may be sequentially provided to the pixel rows PXR at horizontal time intervals. In an embodiment, the n^{th} clock signal PWM_CLK[n] and the n^{th} emission signal EM[n] provided to the n^{th} pixel row PXR[n] may be signals shifted by n−1 horizontal time durations from the first clock signal and the first emission signal provided to the first pixel row, respectively, for example. In this case, the display panel 110 may be driven in a sequential emission manner in which the pixel rows sequentially emit light.

In an embodiment, the clock signals PWM_CLK and the emission signals EM may be simultaneously provided to the pixel rows PXR. In an embodiment, the n^{th} clock signal PWM_CLK[n] and the n^{th} emission signal EM[n] provided to the n^{th} pixel row PXR[n] may be signals that are the same as the first clock signal and the first emission signal provided to the first pixel row, respectively, for example. In this case, the display panel 110 may be driven in a simultaneous emission manner in which the pixel rows simultaneously emit light.

The controller 140 may control an operation (or driving) of the data driver 120 and an operation (or driving) of the gate driver 130. The controller 140 may provide the second image data IMD2 and the first control signal CNT1 to the data driver 120, and may provide the second control signal CNT2 to the gate driver 130. The controller 140 may generate the second image data IMD2, the first control signal CNT1, and the second control signal CNT2 based on first image data IMD1 and a control signal CNT0. The controller 140 may generate the second image data IMD2 by compensating for the first image data IMD1.

Referring to FIGS. 1 and 19, the pulse width modulator PWM of the pixel PX may generate the pulse width modulation signal PWMS based on the first to eighth data bits D0[m] to D7[m] stored in the pulse width modulation controller PWMC without rewriting the first to eighth data bits D0[m] to D7[m] when the display panel 110 displays a still image. When the display panel 110 displays the still image, the grayscale indicated by the first to eighth data bits D0[m] to D7[m] may be the same for a plurality of frames, and thus, the pulse width modulator PWM may generate the pulse width modulation signal PWMS without rewriting the first to eighth data bits D0[m] to D7[m]. Accordingly, power consumption of the pixel PX may be reduced.

The pulse width modulator PWM of the pixel PX may generate the pulse width modulation signal PWMS based on the first to eighth data bits D0[m] to D7[m] stored in the pulse width modulation controller PWMC without rewriting the first to eighth data bits D0[m] to D7[m] when the display panel 110 is driven by an amoled impulsive driving (“AID”) method. The AID method may be a driving method in which one frame includes a plurality of emission periods. When the display panel 110 is driven by the AID method, the grayscale indicated by the first to eighth data bits D0[m] to D7[m] during the plurality of emission periods included in one frame may be the same, and accordingly, the pulse width modulator PWM may generate the pulse width modulation signal PWMS without rewriting the first to eighth data bits D0[m] to D7[m]. Accordingly, the power consumption of pixels PX may be reduced.

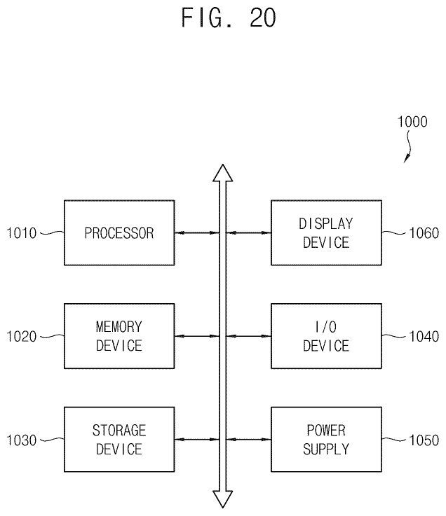

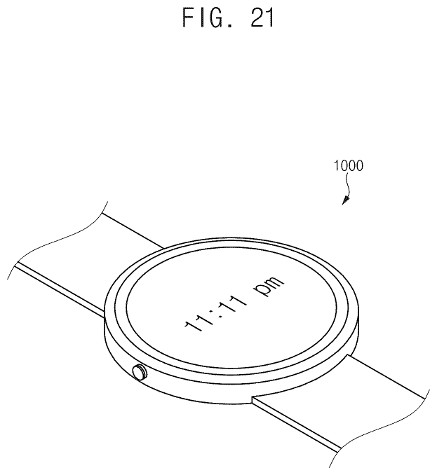

FIG. 20 is a block diagram showing an embodiment of an electronic apparatus 1000. FIG. 21 is a diagram showing an embodiment in which the electronic apparatus 1000 of FIG. 20 is implemented as a smart watch.

Referring to FIGS. 20 and 21, the electronic apparatus 1000 may include a processor 1010, a memory device 1020, a storage device 1030, an input/output (“I/O”) device 1040, a power supply 1050, and a display device 1060. The electronic apparatus 1000 may further include a plurality of ports capable of communicating with a video card, a sound card, a memory card, a USB device, or the like, or communicating with other systems.

In an embodiment, as illustrated in FIG. 21, the electronic apparatus 1000 may be implemented as a smart watch. However, the disclosure is not limited thereto, and in another embodiment, the electronic apparatus 1000 may be implemented as a television, a mobile phone, a video phone, a smart pad, a tablet personal computer (“PC”), a vehicle navigation system, a laptop, a head-mounted display, an artificial reality (“AR”) device, etc.

The processor 1010 may perform predetermined calculations or tasks. In an embodiment, the processor 1010 may be a microprocessor, a central processing unit (“CPU”), or the like. The processor 1010 may be connected to other components through an address bus, a control bus, a data bus, or the like. In an embodiment, the processor 1010 may also be connected to an expansion bus such as a peripheral component interconnect (“PCI”) bus.

The processor 1010 may control the display device 1060. In an embodiment, the processor 1010 may provide the first image data IMD1 of FIG. 19 and the control signal CNT0 of FIG. 19 to the display device 1060.

The memory device 1020 may store data desired for an operation of the electronic apparatus 1000. In an embodiment, the memory device 1020 may include: a nonvolatile memory device such as an erasable programmable read-only memory (“EPROM”), an electrically erasable programmable read-only memory (“EEPROM”), a flash memory, a phase change random access memory (“PRAM”), a resistance random access memory (“RRAM”), a nano floating gate memory (“NFGM”), a polymer random access memory (“PoRAM”), a magnetic random access memory (“MRAM”), or a ferroelectric random access memory (“FRAM”); and/or a volatile memory device such as a dynamic random access memory (“DRAM”), a static random access memory (“SRAM”), or a mobile DRAM, for example.

The storage device 1030 may include a solid state drive (“SSD”), a hard disk drive (“HDD”), a compact disc read-only memory (“CD-ROM”), or the like. The I/O device 1040 may include: an input device such as a keyboard, a keypad, a touch pad, a touch screen, or a mouse; and an output device such as a speaker or a printer. The power supply 1050 may supply a power desired for the operation of the electronic apparatus 1000. The display device 1060 may be connected to other components through the buses or other communication links. The display device 1060 may correspond to the display device 100 of FIG. 19.

In a pixel included in the display device 1060, a pulse width modulator may generate a pulse width modulation signal using a digital logic, and thus, a pulse width of a driving current flowing through a light-emitting element may be accurately controlled, and the pixel may accurately represent the grayscale. Further, each of the pixels may accurately represent the grayscale, and thus, display quality of the display device 1060 may be improved.

The display device in the embodiments may be applied to a display device included in a computer, a notebook, a mobile phone, a smart phone, a smart pad, a smart watch, a portable media player (“PMP”), a personal digital assistance (“PDA”), a motion pictures expert group audio layer III (“MP3”) player, or the like.

Although the pixel, the display device, and the electronic apparatus in the embodiments have been described with reference to the drawings, the illustrated embodiments are examples, and may be modified and changed by a person having ordinary knowledge in the relevant technical field without departing from the technical spirit described in the following claims.

What is claimed is:

1. A pixel comprising:
a light-emitting element through which a driving current flows;
a light-emitting element driver which generates the driving current based on a pulse width modulation signal; and
a pulse width modulator which generates the pulse width modulation signal based on first to k^{th} data bits, k being a natural number greater than 2, and the pulse width modulator including:
a data writer which writes the first to k^{th} data bits in response to a scan signal;
a pulse width modulation controller which stores the first to k^{th} data bits and sequentially outputs the first to k^{th} data bits in response to a clock signal; and
a pulse width modulation signal generator which generates the pulse width modulation signal in response to the first to k^{th} data bits and an emission signal.

2. The pixel of claim 1, wherein the pulse width modulation controller includes:
first to k^{th} flip-flops which shift the first to k^{th} data bits in response to the clock signal; and
first to k^{th} connection transistors which connect the first to k^{th} flip-flops in response to the scan signal.

3. The pixel of claim 2, wherein the first to k^{th} data bits are written to the first to k^{th} flip-flops at a rising edge or a falling edge of the clock signal within an activation period of the scan signal.

4. The pixel of claim 2, wherein the first to k^{th} data bits are shifted between the first to k^{th} flip-flops at a rising edge or a falling edge of the clock signal within an activation period of the emission signal.

5. The pixel of claim 2, wherein an emission length corresponding to each of the first and k^{th} data bits is an interval between a rising edge or a falling edge of the emission signal and a rising edge or a falling edge of the clock signal neighboring the rising edge or the falling edge of the emission signal.

6. The pixel of claim 2, wherein an emission length corresponding to each of the second to k−1^{th} data bits is an interval between neighboring pulses of the clock signal.

7. The pixel of claim 2, wherein each of the first to k^{th} connection transistors is one of an n-channel metal-oxide-semiconductor transistor, a p-channel metal-oxide-semiconductor transistor, and a complementary metal-oxide-semiconductor transistor.

8. The pixel of claim 2, wherein the data writer includes:
first to k^{th} writing transistors which write the first to k^{th} data bits to the first to k^{th} flip-flops in response to the scan signal.

9. The pixel of claim 8, wherein each of the first to k^{th} writing transistors is one of an n-channel metal-oxide-semiconductor transistor, a p-channel metal-oxide-semiconductor transistor, and a complementary metal-oxide-semiconductor transistor.

10. The pixel of claim 2, wherein the pulse width modulation signal generator includes:
a logic gate which generates the pulse width modulation signal in response to a k^{th} output signal or a k^{th} inverted output signal output from the k^{th} flip-flop and the emission signal.

11. The pixel of claim 10, wherein the logic gate is one of a NAND gate, an OR gate, a NOR gate, and an AND gate.

12. The pixel of claim 10, wherein the pulse width modulation signal generator further includes:
a level shifter which changes a voltage level of the pulse width modulation signal.

13. The pixel of claim 1, wherein the light-emitting element driver includes:
an emission transistor which forms a current path of the driving current in response to the pulse width modulation signal; and
a current source which controls an amplitude of the driving current.

14. The pixel of claim 13, wherein the emission transistor is one of a p-channel metal-oxide-semiconductor transistor and an n-channel metal-oxide-semiconductor transistor.

15. The pixel of claim 13, wherein the emission transistor is connected to a line which transmits an emission high voltage,
wherein the light-emitting element is connected to a line which transmits an emission low voltage, and
wherein the current source is connected between the emission transistor and the light-emitting element.

16. The pixel of claim 13, wherein the light-emitting element is connected to a line which transmits an emission high voltage,
wherein the emission transistor is connected to a line which transmits an emission low voltage, and
wherein the current source is connected between the light-emitting element and the emission transistor.

17. A display device comprising:
a display panel including pixels, each of the pixels including:
a light-emitting element through which a driving current flows;
a light-emitting element driver which generates the driving current based on a pulse width modulation signal; and
a pulse width modulator which generates the pulse width modulation signal, the pulse width modulator including:
a data writer;
a pulse width modulation controller; and
a pulse width modulation signal generator which generates the pulse width modulation signal;
a data driver which provides first to k^{th} data bits corresponding to a grayscale to each of the pixels, k being a natural number greater than 2; and
a gate driver which provides scan signals, clock signals, and emission signals to the pixels,
wherein the pulse width modulator generates the pulse width modulation signal based on the first to k^{th} data bits,
the data writer writes the first to k^{th} data bits in response to a scan signal of the scan signals,
the pulse width modulation controller stores the first to k^{th} data bits and sequentially outputs the first to k^{th} data bits in response to a clock signal of the clock signals, and
the pulse width modulation signal generator generates the pulse width modulation signal in response to the first to k^{th} data bits and an emission signal of the emission signals.

18. The display device of claim 17, wherein each of the scan signals, the clock signals, and the emission signals are sequentially provided to pixel rows of the display panel at horizontal time intervals.

19. The display device of claim 17, wherein the scan signals are sequentially provided to pixel rows of the display panel at horizontal time intervals, and
wherein each of the clock signals and the emission signals are simultaneously provided to the pixel rows.

20. An electronic apparatus comprising:
a display device which displays an image and a processor which controls the display device, the display device comprising:
a display panel including pixels, each of the pixels including:
a light-emitting element through which a driving current flows;
a light-emitting element driver which generates the driving current based on a pulse width modulation signal; and
a pulse width modulator which generates the pulse width modulation signal based on the first to k^{th} data bits, the pulse width modulator including:
a data writer;
a pulse width modulation controller; and
a pulse width modulation signal generator which generates the pulse width modulation signal;
a data driver which provides first to k^{th} data bits corresponding to a grayscale to each of the pixels, k being a natural number greater than 2; and
a gate driver which provides scan signals, clock signals, and emission signals to the pixels,
wherein the pulse width modulator generates the pulse width modulation signal based on the first to k^{th} data bits,
the data writer writes the first to k^{th} data bits in response to a scan signal of the scan signals,
the pulse width modulation controller stores the first to k^{th} data bits and sequentially outputs the first to k^{th} data bits in response to a clock signal of the clock signals, and
the pulse width modulation signal generator generates the pulse width modulation signal in response to the first to k^{th} data bits and an emission signal of the emission signals.
